(19) United States
(12) Patent Application Publication
(10) Pub. No.: US 2024/0240420 A1
(43) Pub. Date: Jul. 18, 2024

(54) SYSTEM, METHOD AND APPARATUS FOR SYNTHETIC FIELD PAINT AND LINE REMOVAL WITH EDGER BRUSHES AND VACUUMING

(71) Applicant: Kromer Company, Long Lake, MN (US)

(72) Inventors: Nathan G. Bergquist, Mound, MN (US); Alan L. Hentges, Ham Lake, MN (US); Nathan S. Olson, Mound, MN (US)

(73) Assignee: Kromer Company, Long Lake, MN (US)

(21) Appl. No.: 18/412,969

(22) Filed: Jan. 15, 2024

Related U.S. Application Data
(60) Provisional application No. 63/439,103, filed on Jan. 14, 2023.
(60) Provisional application No. 63/448,612, filed on Feb. 27, 2023.

(51) Int. Cl. E01H 15/00; B08B 1/12; B08B 3/02; B08B 3/08; C09D 9/00

(52) U.S. Cl. CPC E01H 15/00; B08B 1/12; B08B 3/024; B08B 3/08; C09D 9/00

(57) ABSTRACT

An athletic field removal/extraction and vacuuming device or apparatus configured to be pushed/pulled by a vehicle to remove residue paints and other particles, such as from indicia or logos, lettering and lines on a synthetic or other athletic field, particularly straight lines on the field. The apparatus comprises a frame having a coupling mechanism for mounting the apparatus to the vehicle. At least one sprayer sprays a chemical remover onto the indicia, which loosens or dissolves the paint. After brushing the line for paint removal with brushes, and with water added, the paint particles so dislodged, including any chemical remover and the dissolving indicia on the field are vacuumed up into a recovery tank for processing elsewhere. Also disclosed are methods of so cleaning a synthetic or other athletic fields and removing by vacuuming accumulated detritus.

### CROSS REFERENCE TO RELATED PATENT APPLICATION

The instant application is related to U.S. Ser. No. 63/439,103, filed Jan. 14, 2023, and entitled “SYSTEM, METHOD AND APPARATUS FOR SYNTHETIC FIELD PAINT REMOVAL AND VACUUMING,” and U.S. Ser. No. 63/448,612, filed Feb. 27, 2023, and entitled “SYSTEM, METHOD AND APPARATUS FOR SYNTHETIC FIELD PAINT REMOVAL WITH EDGER BRUSHES AND VACUUMING,” both with the same Applicant, the entireties of which are incorporated by reference herein.

### FIELD OF THE INVENTION

The present invention relates to athletic field maintenance equipment, and more particularly to maintenance equipment used to clean lettering and logos on synthetic athletic fields and removing or extracting the paint markings from the synthetic turf fibers and infill material, thereby allowing swift sport changeovers and minimizing field hardness and shadowing effects; more particularly to the improved erasure of lines and other indicia from the surfaces of fields, with the removal of all particles by vacuuming.

### BACKGROUND OF THE INVENTION

Synthetic turf fiber athletic fields have specific characteristics, which make them difficult to prepare, maintain and clean. Maintenance requirements are also constantly being defined by governing organizations. Often times, with heavy use by sports teams, marching bands, and others, the field surfaces of synthetic athletic fields quickly become permanently worn with the infill material, typically rubber pellets or similar material, being compacted, clumped and encrusted with atmospheric dust and dirt.

In addition to forming ruts, deteriorating performance and otherwise degrading the quality and safety of synthetic turf athletic fields, heavy use also quickly diminishes the aesthetic look of the fields.

Often times capping occurs on synthetic turf athletic fields. Capping is a term frequently used to refer to the situation where the infill of a synthetic turf field becomes compacted and then dirt/dust glues it together and creates a hard pan of infill. This further damages the synthetic grass fibers or blades, because when grass fibers protrude out of the hard pan of encrusted infill, and are stepped on by athletes' shoes or cleats, the fibers are sharply bent over and are creased, or sometimes even severed, by this action. With many synthetic athletic fields being used in televised events, it is typically desirable to maintain both the quality and look of the field. These goals have been difficult to achieve in the art.

With the need for uniformity and a desire for safety, the National Football League (NFL) and other organizations frequently test the field surfaces for consistency and surface hardness. For example, the infill within a synthetic field must also be evenly distributed in order to create a level and consistent playing surface. In cases where the infill is uneven, e.g., in an area of paint and other debris accumulation, it is necessary to add, remove, or smooth that surface area until it meets the NFL's standards. By taking these measures, the league makes sure that the various playing fields are safe and playable for all of the teams. Indeed, many current systems and techniques are designed to smooth over the accumulated debris on the field to make the surface even, without addressing the removal of the debris.

Further, even if the fields are well maintained, the long-term effects of paint build, i.e., repeated applications of paint onto a surface causes the paint to adhere unevenly and also build up, causing field hardness and also shadowing to high-profile synthetic fields, which is accentuated under bright lights. Further, with the ongoing emphasis on player safety, the frequent testing of playing surfaces and demands for immediate remedial action, there is a dire need for an effective and efficient technique to accomplish the difficult task of simply maintaining a synthetic field. Further, as discussed, since existing techniques hardly address the problems of debris accumulation in field maintenance, there is a need for a more cost-effective and efficient way to provide this service, preferably with add-ons to the existing equipment.

With the growing importance to sports to Society, and the failure to address these current problems, there is a present and important need for a solution, whereby apparatuses and techniques not only for cleaning and maintaining these fields are needed, but also removal of accumulated debris. Indeed, improvements in the clean and full removal and extraction of existing paint field logos and lines are also needed, e.g., so that new and different game lines can be applied quickly.

With current devices and methodologies unable or grossly inefficient about the removal of game lines and logos from a field surface, there is a clear need for apparatuses and techniques to solve this problem, such as the techniques set forth herein.

### SUMMARY

In an exemplary embodiment, disclosed is a synthetic athletic field lettering, logo and line extraction apparatus configured to be pushed (or pulled) by a vehicle across an athletic field surface, such as a synthetic field surface, for use in removing prior logos from the field surface and extracting by vacuum the residue paint and other materials on the playing field, thereby creating a new surface for the insertion of new lettering, lines and logos, and provide a safe playing surface. These techniques can also be employed to treat or soften a hard field by removing the unwanted build up of paint and other detritus embedded within the synthetic field material.

The synthetic athletic field extraction apparatus comprises a vehicle having a coupling mechanism at a front or at a back of the apparatus for mounting or connecting to a frame, onto which one or more extraction apparatuses are connected. Although modularization of components is preferred, alternatively the vehicle and removal apparatuses here can be one device.

In some exemplary embodiments, the extraction apparatus employs a spray device for pre-spraying a chemical remover on the paint and other markings on a synthetic field, which aids in paint removal.

These embodiments could further include spraying water and scrubbing or treating the field surface with downward pressure, perhaps using a number of brushes, under careful operator control, thereby softening and readying the removed paint and other residue for suction, as compared to prior art techniques of just dissipating the detritus on site into the field's drain system, creating future hardness and shadowing problems, as discussed hereinabove and hereinbelow.

In other exemplary embodiments, to improve upon the above, the synthetic athletic field extraction apparatus comprises a vacuum system, also attached or coupled to the frame, e.g., between the aforesaid scrubbing brushes and the vehicle, which collects the various liquids and loosened paint materials from the aforesaid treated surface, which become solubilized, and the vacuum system then removes the admixture of chemicals, added water, paint particles loosened and other residue from the field entirely.

In these embodiments, the aforesaid paint or other markings on the field surface are loosened, e.g., by the chemicals and the brushes, and admixed within a water-infused solution or slurry by the above sprayers and is vacuumed up by a vacuum and directed into a recovery tank, instead of the typical prior art techniques just dispersing the detritus or residue into the particular field's drain system. Further, with particular usages, e.g., line removal, there is an increased need to completely remove the paint so that different lines for different sports games can later be applied, and so that there is no confusion due to line remnants being present, thereby allowing use and re-use of a given arena or field by different sports with different games lines and logos.

In accordance with additional embodiments, a method of extracting paint or other markings from a synthetic athletic field is provided. The method includes a step of using a vehicle to push (or pull) an extraction implement across the synthetic athletic field, particularly over the lettering, lines and logos on the synthetic athletic field, and after spraying the designated areas with a chemical remover, water and other liquids, thereby loosening the paint or other residue particles, and applying brushes, helping to further loosen the paint from the artificial fibers. The instant invention is particularly directed to the complete removal, preferably in one pass, of the line paint particles from the playing field.

The method of the instant invention also includes the step of vacuuming the treated areas on the synthetic athletic field and lines thereon to physically remove the chemicals, sprayed water, and the loosened paint and other detritus materials accumulating on a field by vacuuming away these compounds, thereby minimizing further damage to the synthetic field, and also providing a mechanism to reduce the hardness of the playing field caused by the prior application of paint and other particles left behind, e.g., in a normal grooming or maintenance process.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Drawings, where like reference numerals designate like structural and other elements, in which:

FIG. 1 shows a side perspective view of a field cleaning assembly pursuant to the teachings of the present invention in a first embodiment, showing a connected vehicle, and including a number of brushes and fluid spraying components, all on a frame shown affixed to a front portion of the vehicle, and showing a vacuum device and removal system thereon to remove debris from a field;

FIG. 2 illustrates a front perspective view of the field cleaning assembly shown in FIG. 1

FIG. 3 is side perspective view of the vacuum device pursuant to the principles of the present invention in said first embodiment, as shown in FIGS. 1 and 2, showing the vacuum device in deployment between the vehicle and the brushes components;

FIG. 4 is a top elevational view of the vacuum device shown in FIG. 3;

FIG. 5 is a bottom view of the vacuum device shown in FIGS. 1-4, removed from the field cleaning assembly, showing the vacuum ports and fluid channels used in cleaning a field of debris;

FIG. 6 is a side view of a line cleaning device assembly, pursuant to the teachings of the present invention in a second embodiment or configuration, also showing a connected vehicle, and including brushes and fluid spraying components, all on a frame and shown affixed to a side portion of the vehicle, and showing a vacuum device and system thereon to remove paint and other debris from a given line of paint on a field surface;

FIG. 7 is side perspective view of the vacuum device pursuant to the principles of the present invention in said second embodiment, as shown in FIG. 6, showing the vacuum device in deployment along the side of the vehicle, along with various brushes and sprayer components;

FIG. 8 is a side perspective representative view of components in the above configurations, as shown in the above FIGURES, in operation upon a field surface, such as a field line, showing the chemical treatments, brushing, water rinsing, pooling and solubilizing the residues for removal, and vacuuming away the detritus; and

FIG. 9 is a side view of another configuration of the present invention in another deployment, combining the componentry of the first embodiment, the field cleaning assembly as shown in FIGS. 1 and 2, and the equipment of the second embodiment, as shown in FIGS. 6 and 7, in a third embodiment or modular configuration, with respective vacuum device and other components, to both generally remove debris on a field surface and also remove paint and other debris on a given line on the field surface.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

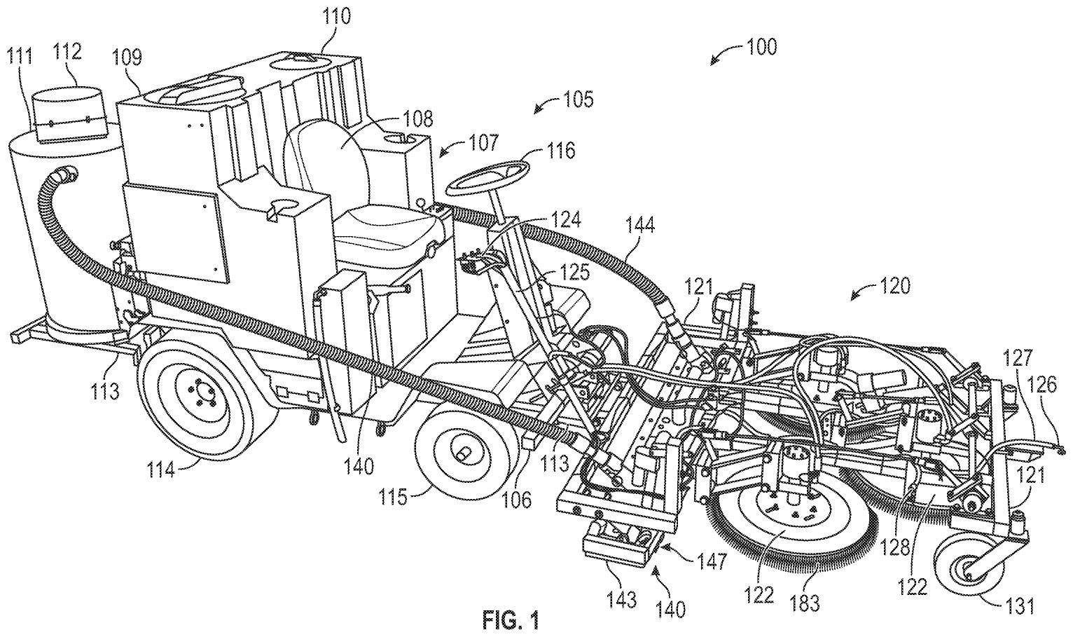

With reference now to FIG. 1 of the DRAWINGS, there is shown a field cleaning apparatus, assembly or system, generally designated by the reference numeral 100, which is employed pursuant to a first embodiment of the present invention. Also shown is a representative self-propelled athletic field maintenance tractor or vehicle, generally designated by the reference numeral 105, which can be used with the herein disclosed field cleaning system 100, along with sprayers brushes, extraction and vacuuming apparatuses and methods in other exemplary embodiments discussed in more detail hereinbelow. However, the concepts discussed herein are to be construed as applying equally well to a unit which is not self-propelled, and configured as an implement to be connected to, pulled by, guided (i.e., steered), and/or powered by a vehicle such as a tractor or utility vehicle.

Nonetheless, in a currently preferred configuration, a vehicle 105 attaches to and pushes the aforementioned field cleaning system 100, whereby a driver or operator of the vehicle is guiding or steering the system 100 across the field. It should, of course, be understood that through imaging and geo-positioning, the precise removal of paint lines, logos and other branding on a game field, along with other detritus, can be automated, i.e., perhaps even done without a driver, just as is currently done with automated vehicles and equipment in agriculture, trucking and some driving.

The numerous details of the above vehicle 105, as well as the operations of a synthetic field grooming and maintenance system are found in Applicant's U.S. Pat. No. 9,371,617, which is incorporated in its entirety herein by reference. As many of the same components in Applicant's product line, some of which are illustrated and described in the aforesaid patent, are employed in the instant invention, this modularity in design and purpose is an inventive feature also incorporated herein.

It should thus be understood that the aforesaid vehicle or tractor 105 may be employed in both grooming and also in preparing a given athletic field, and also, when configured, in removing or extracting the indicia generally or specifically, i.e., the paints for lettering, logos and other game lines, the subject herein.

Indeed, Applicant is a leader in the many aspects of athletic field grooming, maintenance and indicia application, i.e., painting the requisite lines, logos and lettering for the respective game and teams at play. Applicant is also a leader in various paint and other indicia removal apparatuses and techniques, which are equally important in contexts where different sports are contemporaneously played on the same field, for example, the next day.

Thus, since many high-end athletic fields have multiple uses, among multiple sports, the names of the teams, the game lines and insignia, endzones, numbers, and many other distinguishing features, there is a need to change perhaps all of these markings or indicia between the discrete uses, i.e., removing one and entirely replacing the now cleaned surface with the indica for the next game, the new team, the next sponsors, and so forth. For example, the game lines for soccer, football, lacrosse, baseball and other sports differ markedly, and the complete erasure of the previous indicia is absolutely necessary to the preparation for a new and different upcoming game, which may be played soon.

For some athletic or game field surfaces these indicia can be removed by resort of sprayers and brushes, and, as noted, Applicant is a leader in the equipment and chemicals for this. The instant invention builds upon Applicant's success in this physical and chemical indicia removal, and upon the teachings set forth in the aforesaid patent and herein. Accordingly, the present invention has attachments to the aforesaid vehicle 105, which through a number of spray nozzles spray the painted surface portions (or all portions as well) of the field surface with a chemical remover product, as well as water, and then employs a vacuum system to remove the various liquids and materials loosened up.

In this first embodiment, illustrated in FIG. 1, there is shown an improved system for the extraction or removal of the aforesaid paint and other debris left upon a playing field, particularly accumulated paint particles, such as from the painted lines. In operation, the instant invention is preferably a one-pass removal process, with preferably one operator of the system. Applicant wishes to note that with the proper synthetic paint being used prior on the field, the remover apparatus of the instant invention will increase the efficiency of use for large stadium venues, and field turn arounds through the improved configuration for deployment shown herein.

Tractor or vehicle 105 in FIG. 1 is depicted as a mobile vehicle, including a frame 106, on which is installed an operator station 107 with a seat, generally designated by the reference numeral 108, and an engine and fuel source (not shown). Also shown is a fluid containment tank, generally designated by the reference numeral 109, respectively housing, a chemical for the removal of paint from the field. Also shown is a water containment tank, generally designated by the reference numeral 110, which helps create a slurry for subsequent removal of debris. The usage and admixture of these liquids in treating the field are further described hereinbelow. Also shown are respective fittings and hoses therefrom bringing these liquids forward, as shown and further described hereinbelow.

Also shown is a recovery tank, generally designated by the reference numeral 111, which collects the liquids from the field surface for disposal elsewhere (instead of just dispersing this detritus admixture onto the field surface as in prior art systems), and to aid in the removal of the collected debris, a suction motor, generally designated by the reference numeral 112, is shown, which provides the requisite suction pressure for the vacuum devices described in more detail hereinbelow.

Attached to the aforesaid frame 106 and at the front and rear of the tractor 105 are lift mechanisms, generally designated by the reference numeral 113, such as a conventional hydraulic lift mechanism and cylinder, which provides modes of operation to provide pressure up and down, a free-floating mode, and a mode that locks the position at selected heights. Thus, through the front lift 113, the position and height of the apparatus 100 vis-à-vis the vehicle 105 and the field surface can be adjusted. The aforesaid vehicle includes variable speed drive wheels, generally designated by the reference numeral 114, and steerable wheels, generally designated by the reference numeral 115. The vehicle 105 further includes a steering wheel, generally designated by the reference numeral 116, by which an operator, seating on seat 108 of the operator station 107, can guide the vehicle 105 on the field, and, as in the second embodiment described hereinbelow, can guide the vehicle 105 for more precise line or other paint removals.

More details on the operations of the vehicle 105 can be found in Applicant's aforesaid U.S. Pat. No. 9,371,617 (“Applicant's '617 patent”), which is incorporated by reference.

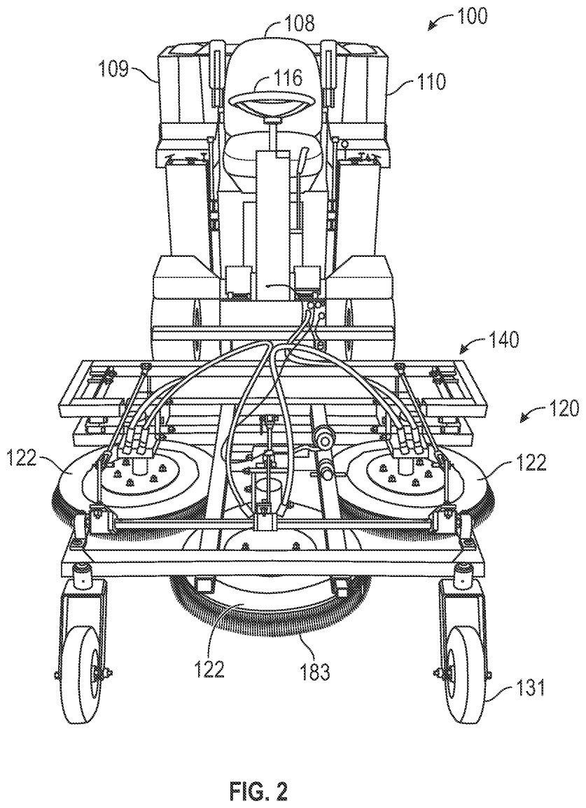

As shown in FIG. 1 and also in FIG. 2 of the DRAWINGS in this embodiment, assembly or apparatus 100 includes a field cleaning assembly, generally designated by the reference numeral 120, which is supported on a frame or framework, generally designated by the reference numeral 121, to support the various components.

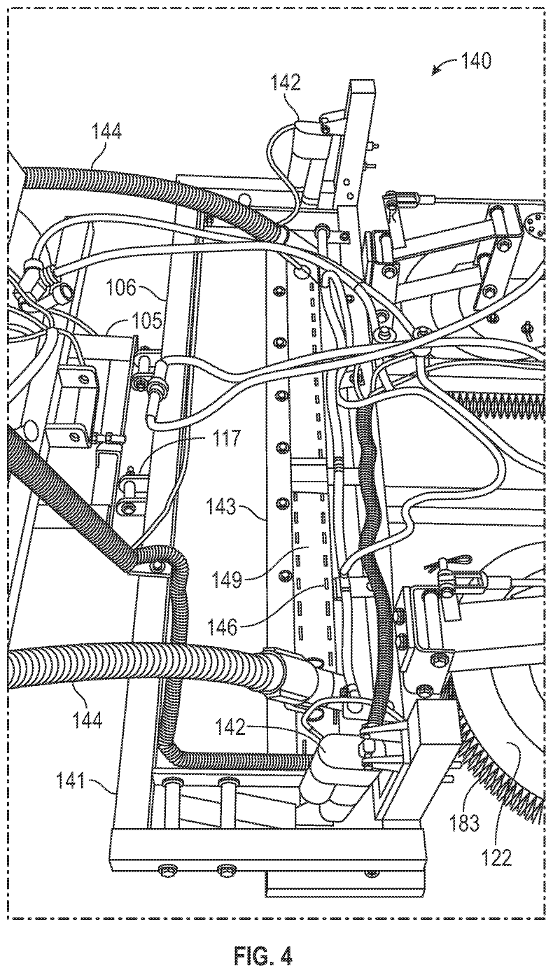

As illustrated, the field cleaning assembly 120, in this embodiment, includes three brushes, each generally designated by the reference numeral 122, attached to the aforesaid framework 121, which is secured to the front of said vehicle 105, e.g., using a number of removable bolts or couplers, generally designated by the reference numeral 117, and shown in FIG. 4. The brushes 122 in this embodiment are arranged in a triangular configuration, as shown, with a leading brush and two other brushes disposed behind it. In this manner, the vehicle 105, as well as the assembly 100, can be utilized separately, e.g., using a different vehicle for propulsion. As also shown are respective brush motors, generally designated by the reference numeral 123, that drive the brushes 122 in operation, i.e., the speed and position with respect to the field surface. In a preferred embodiment, the brush motors 123 are Hydroliz Drive motors.

As discussed, the application of water and chemical removers to the field surface underneath and the precision application of the brushes, i.e., the amount of downward pressure applied and other factors, will loosen the paint and other particles for removal by the vacuum system immediately behind, i.e., the operator of the vehicle 105 positions the brushes 122 over the field area of interest and simply continues the forward motion, whereby the vacuum system automatically suctions the aforesaid debris, in a manner discussed hereinbelow.

It should also be understood, however, the precise application of and duration for the suction can be controlled by the vehicle operator, e.g., using a control panel, generally designated by the reference numeral 124, which is on an arm, generally designated by the reference numeral 125, affixed to the frame 121 of the aforedescribed field cleaning assembly 120 and extending toward the operator station 107, such that the operator can easily reach and manipulate the control panel 124.

With reference again to FIG. 1, a number of sprayers are shown, by which the paint and detritus on a field surface can be treated and removed. It should be understood that the configurations and other specifics of the respective sprayers, e.g., the heads, nozzles, and other features will differ pursuant to the purpose and compositions, as described in more detail in Applicant's '617 patent. For example, in a preferred embodiment, there is a front pre-scrub sprayer or chemical sprayer, generally designated by the reference numeral 126, which sprays a paint removal chemical or other chemical for the treatment of the field surface or a field line, as discussed in more detail hereinbelow.

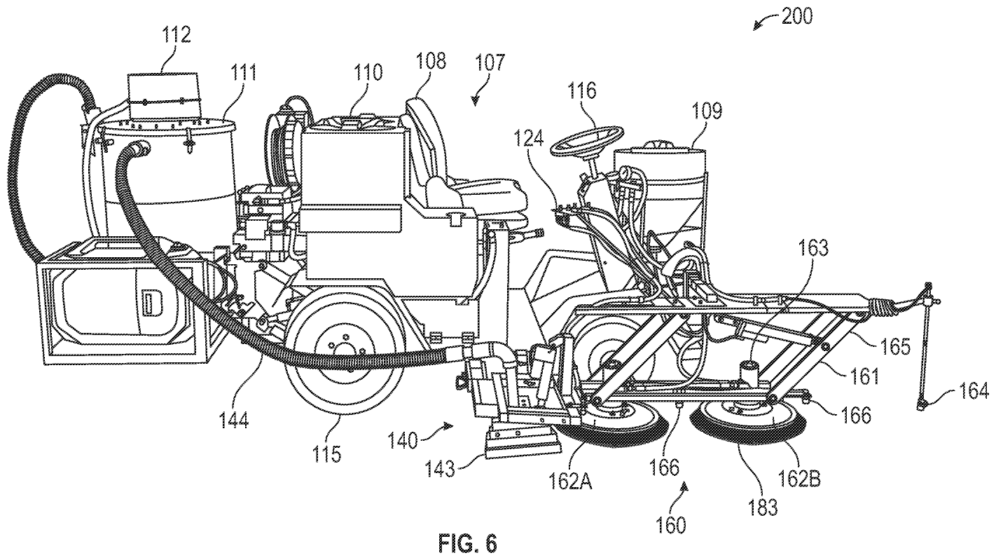

As shown in the Figures, a hose or hoses, generally designated by the reference numeral 127, connect the aforesaid front pre-scrub sprayer 126 to ultimately a chemical source, i.e., the aforementioned fluid containment tank 109, which stores the chemical. As shown in FIG. 1, the chemical tank 109 is shown juxtaposed with the water tank 110. However, as shown in FIG. 6, the chemical tank 109 may be separate from the water tank 110 in another embodiment. The operator, employing the aforementioned control panel 124, governs the duration and amount of the chemical sprayed on to the field. It should be understood that the operator may have gradations or levels for the application of this chemical, e.g., standard, heavy, etc. Similar gradations may apply to the employment of other liquids and pressures described herein. In a preferred embodiment, the chemical employed is a non-foaming biodegradable detergent or compositions equivalent thereto.

Also shown are a number of water sprayers, middle sprayers, generally designated by the reference numeral 128, deployed in front of each of the aforesaid brushes 122 to assist in cleaning the paint from the artificial fibers, infill and other aspects of the field, admixing with the prior sprayed chemicals. It should be understood that the water spray at this point is preferably a light mist. Also shown is a flood sprayer, generally designated by the reference numeral 129, deployed behind the rear brushes 122 and just before a vacuum system described in more detail hereinbelow, which, as discussed in more detail herein, solubilizes the materials present, providing a slurry that admixes the detritus, chemicals and other residues with the flood of water—to be vacuumed away.

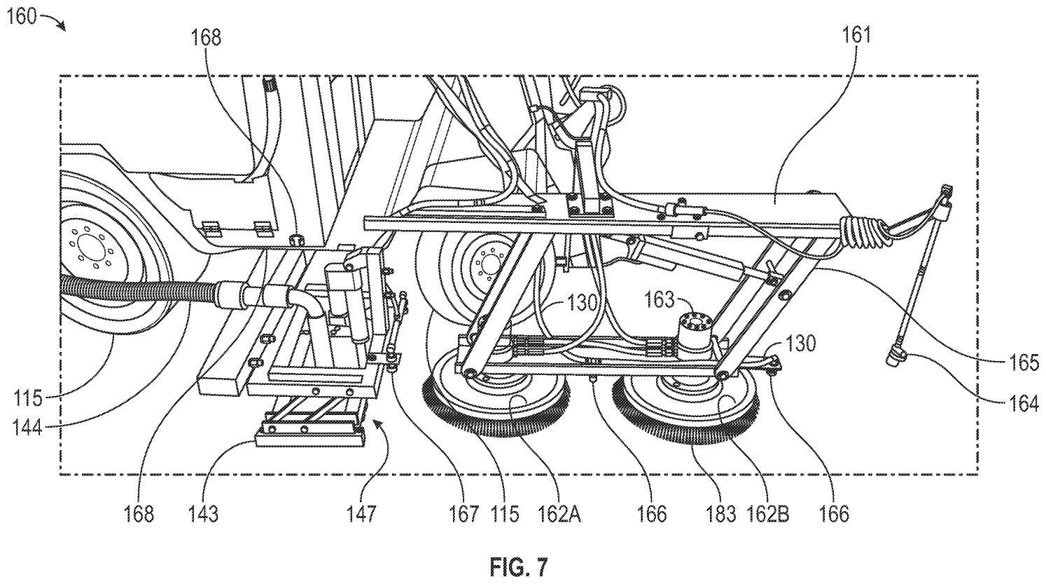

A number of water hoses, generally designated by the reference numeral 130, provide the water to the various water sprayers, as shown in FIGS. 6 and 7 and discussed in more detail hereinbelow. In order to make the apparatus 100, deployed on the frame 121, mobile, the frame 121 includes wheels, generally designated by the reference numeral 131.

One of the problems with prior art field cleaning techniques is so-called paint build, where the paint does not fully wash away and instead permeates the field surface to such a degree that full removal becomes more difficult. As noted, paint build also leads to surface hardness and shadowing, where the cleaned or groomed surface still shows faint versions of the prior indicia mixed with the present, i.e., doing grooming alone is insufficient to deal with thee problems. Naturally, and especially with high-profile institutions, such as the NFL and colleges, this is unsatisfactory. For example, the NFL monitors the field surfaces carefully and inspects each field prior to game use for hardness, whereby areas seemed too hard are a hazard to play—and remedial action is needed immediately. Indeed, these institutions stand to gain much by increasing safety. They further gain by eliminating this shadowing, e.g., increased revenue due to more games in the stadiums. Since shadowing is caused by the non-removal of the residue paint and debris, the instant invention solves this problem by completely removing the particles causing the problems.

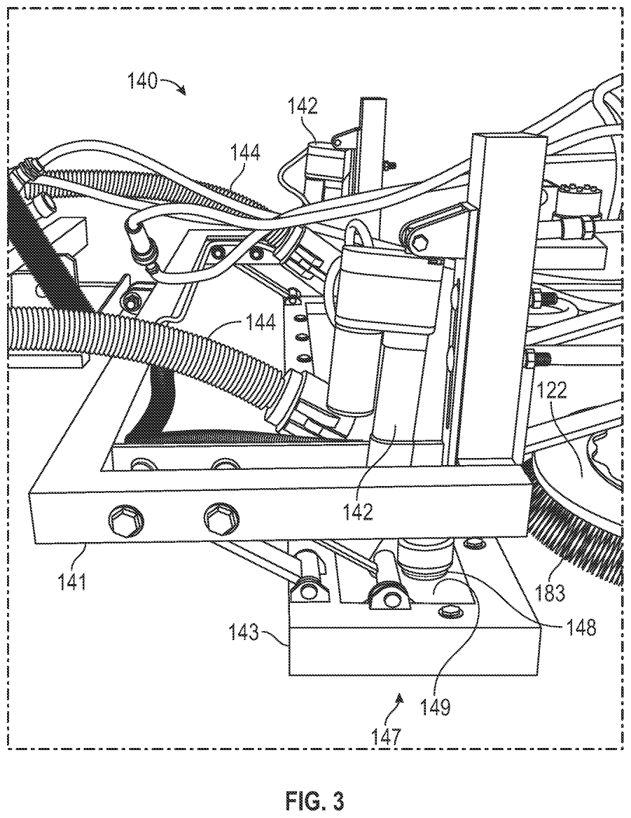

With reference again to FIG. 1 and with further reference to FIGS. 3 AND 4 of the DRAWINGS, there is shown a vacuum assembly or system, generally designated by the reference numeral 140, which is deployed to remove or extract the aforedescribed treated indicia on a field surface. As discussed, after treatment with the chemical remover and brush scrubbing with water, with the resultant slurry admixture, the slurry is vacuumed up. Again, this removal of the problematic particles is a great improvement over the prior art techniques of merely allowing the fluids with the particulates to dissipate into the fields drain system, causing problems later. Despite the deleterious consequences of non-removal, these prior art techniques, however, are still employed by many companies in the industry.

Indeed, by so treating, kneading, flooding, solubilizing and vacuuming away, thereby physically removing the paints and other materials of the indicia, as well as the noxious chemicals, the underlaying surface, i.e., the infill, as well as the fibers of the synthetic turf or field, are cleaned of the previous paints and any foreign materials, softened to reduce hardness, and made ready for a new set of indicia for a new game or sport or another event.

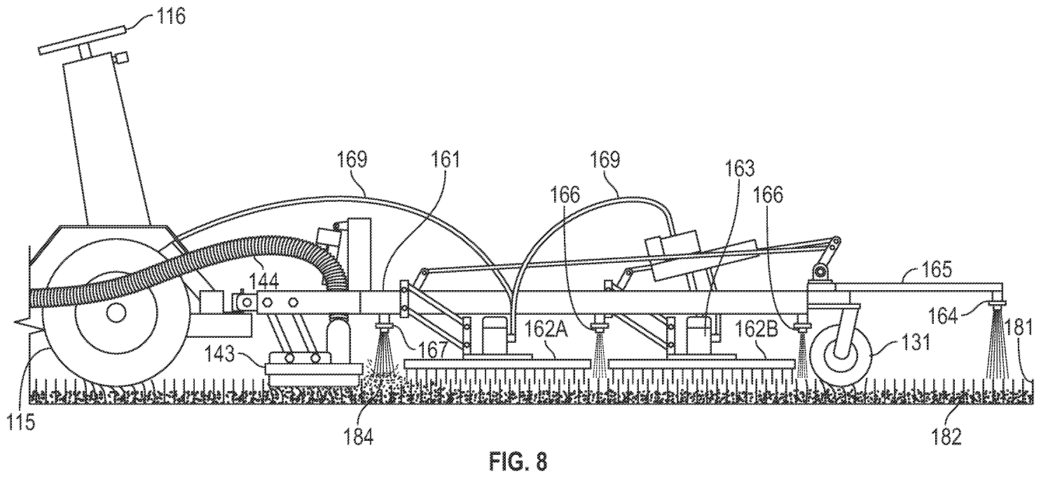

With particular reference now to FIGS. 3 and 4, which focus on the vacuum system 140 shown in FIG. 1, there is shown a vacuum frame, generally designated by the reference numeral 141, which supports the components of the vacuum assembly. Also shown are two actuators, generally designated by the reference numeral 142, at either end of the vacuum system 140, which raise or lower a vacuum device, generally designated by the reference numeral 143, secured thereto. For example, in response to a command from the operator of the vehicle 105, such as through control panel 124, the vacuum device 143 can be lowered to the field surface to suck up materials there via vacuuming pressure. Indeed, as described in more detail hereinbelow, particularly in connection with FIG. 8, the operator can govern the placement of the vacuum device 143 vis-à-vis the field surface, the turf fibers or blades 181 and the infill 182 therein, as also discussed in more detail in connection with FIG. 8 of the DRAWINGS, which best effectuates the recovery of the solubilized materials delivered to the vacuum device 143, e.g., lowering the vacuum device 143 to the level of the hard infill preferably to best “push” the water for delivery to the vacuum ports, which, as discussed hereinabove, are powered by the suction produced by the suction motor 112.

It should be understood that the vacuum device 143 so lowered should not overly press on the blades 181, and preferably not contact the aforesaid infill 182. Thus, the vacuum device 143 should be lowered, e.g., by the operator, to just above the infill 182 so as to not damage it by motion of the vacuum device 143 moving forward, which, as discussed, forms a flood or dam accumulating in front, which is created by a heavy dose or flood of water from a number of flood sprayers 129 deployed. This flood of water sprayed downward admixes with the accumulated liquids and debris, forming the slurry 184.

As also shown in FIGS. 3 and 4, there is at least one exhaust hose, generally designated by the reference numeral 144, which connect the effluent suctioned up by the vacuum device 143, i.e., from the formed slurry 184, to the forementioned recovery tank 111, whereby the waste materials can be deposited for discarding elsewhere. Two such exhaust tubes or hoses 144 are shown in these Figures. It should, of course, be understood that in alternate embodiments, only one exhaust hose 144 may be needed or perhaps more than two. As discussed, the recovery tank 111, with the suction motor 112, generates a suction pressure to the vacuum device 143.

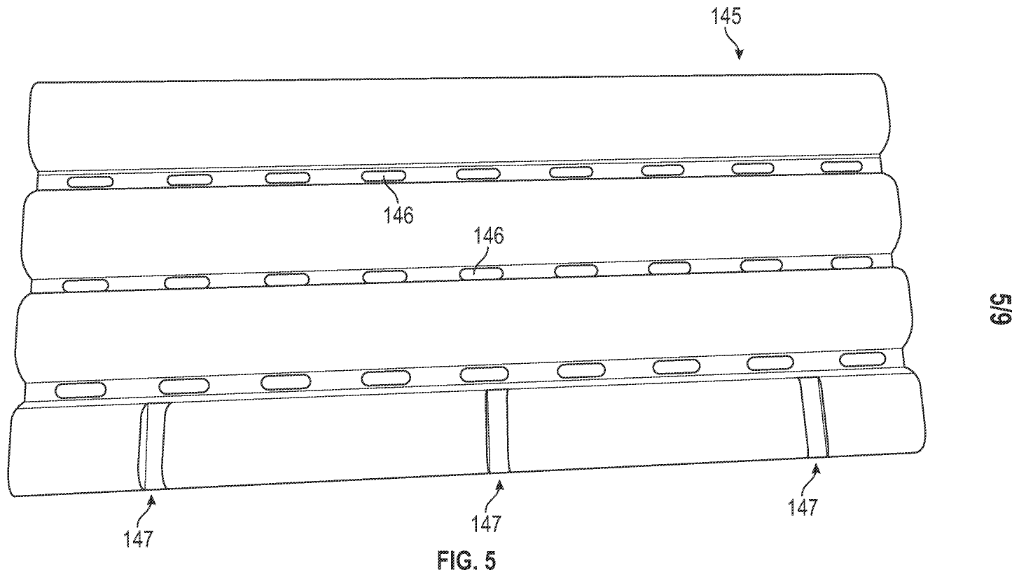

With reference now to FIG. 5 of the DRAWINGS, there is shown the underside of the aforementioned vacuum device 143, which shows a grating, generally designated by the reference numeral 145, with a number of discrete vacuum ports or holes, generally designated by the reference numeral 146, through which the effluent passes on to the exhaust hoses 144 and on to the recovery tank 111, as described.

With the entire vacuum device 143 lowered to the field surface, a position shown in deployment configuration in FIG. 8, the suction will collect all of the water, chemical removers, loosened paint, and other particles caught within the playing field material, which, as discussed, over time create both a hazardous condition and become aesthetically unappealing, i.e., the aforedescribed hardness and shadowing. In other words, the slurry 184 of these chemicals, particulate particles and water are removed.

With further reference to FIG. 5 (and discussed again in connection with FIG. 8), the bottom surface of the vacuum device 143 includes a number of channels or grooves along a leading edge, the respective channels generally designated by the reference numeral 147, whereby when the vacuum device 143 is lowered down to the infill level and the vehicle 105 advances, the slurry 184 of materials built up in front, first moves through the leading edge channels 147 and on to the vacuum grating 145 and the vacuum holes 146 therethrough for removal to the aforesaid recovery tank 111.

It should be understood that although three such channels 147 are depicted, other configurations are contemplated and within the scope of the present invention, so long as the channels 147 provide the necessary drainage for vacuuming.

In operation, Applicant preferably spaces the channels 147 apart along the leading edge of the grate 145, i.e., the nearest edge in the direction of the motion, at distances of about 2 inches to about 10 inches, depending on the strength of the suction power and other factors understood in the art. Additional channel 147 spacings or separations ranges comprise about 4 inches to about 8 inches, with the currently most preferred spacing being about 6 inches.

The depth or height of the channels may also vary, depending on the need, e.g., about ⅜ inch to about ⅝ inch, with ¼ inch being preferred. The width or breadth of the channels 147 may vary also, for example, about ½ inch to about 1 inch, about ⅝ inch to about ⅞ inch, with ¾ inch being currently preferred.

In connection with all of the Figures herein, it should be understood that various connectivities are depicted, i.e., tubes or hoses for the chemicals 127 and water 130 employed by the brushes 122, which are preferably color coded, e.g., yellow for water, clear for the chemicals, and black for the hydraulics, etc., as is understood in the art.

As also mentioned herein, the instant invention is preferably driven entirely by hydraulics, thereby increasing the reliability and duration of the equipment.

Also shown are the exhaust or suction hoses 144 connected at one end to the vacuum device 143, which connect at the other end to the recovery tank 111, with a suction or vacuum device, the aforesaid suction motor 112, powering the suction, as depicted in FIG. 6. The suction device 112 is shown atop the recovery tank 111 to store or recover the aforementioned paint and other debris and the liquids suctioned up.

In this manner, the instant invention is a great improvement over the prior art, which do not perform this recovery and removal function, and are instead glorified carpet cleaners and the like, which require multiple passes, at best, to equal one pass of the instant invention, making them quite inefficient.

With regard to the vacuum device 143, the vacuum holes 146 carry the effluent away, as discussed. In a preferred embodiment, the top surface of the vacuum device 143 is made of a clear material, e.g., a polycarbonate, generally designated by the reference numeral 149, the transparency of which is illustrated in FIG. 4, where the aforesaid grating 145 and the vacuum holes 146 are shown from the other side than that depicted in FIG. 5. Indeed, the polycarbonate cover 149 provides a seal for the vacuum, i.e., inside the of the vacuum device 143 “box” is subject to the full suction force of the aforesaid suction device 112 and this suction is carried to the aforedescribed vacuum holes 146. An air valve, generally designated by the reference numeral 148, as shown and described in connection with FIG. 3, connects to the vacuum device 143, and provides the requisite measure of air needed.

Turning now to FIGS. 6 and 7 of the DRAWINGS, there is shown the aforedescribed field extraction and removal system of the instant invention in deployment in a second currently preferred embodiment, which is particularly directed to the removal of paint and other chemicals deposited on a line on a field surface, but now requiring removal. Indeed, the line cleaning assembly or apparatus, herein generally designated by the reference numeral 160, is a similar and alternative configuration than that shown hereinabove, but which is nonetheless directed to a related and critical function in field surface cleaning processes.

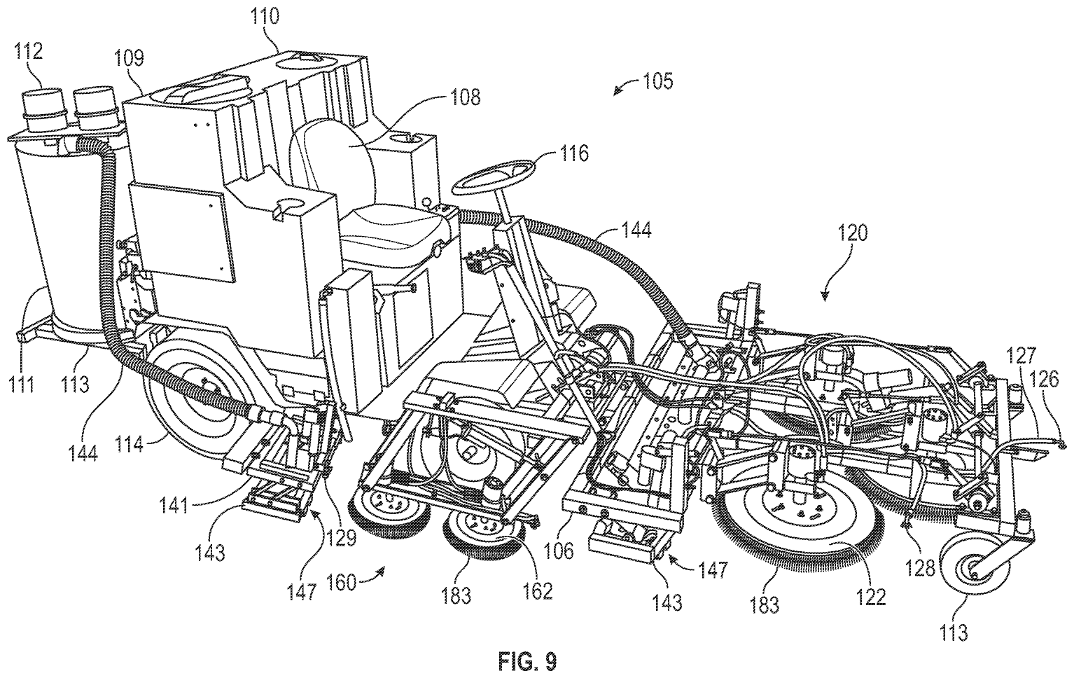

As in the first embodiment, this embodiment 200 employs a vehicle 105, water and chemical sprayers, recovery tanks and most other components, as described hereinabove. As shown in FIG. 6, as well as FIGS. 7 and 9, the line cleaning assembly 160 is deployed along the side of the vehicle 105.

With particular reference to FIG. 7, the line cleaning assembly 160 has at least one support frame, generally designated by the reference numeral 161, onto which two brushes, generally designated by the reference numeral 162, particularly reference numerals 162A and 162B to specify (collectively 162), are disposed in an aligned or serial configuration, as opposed to the aforedescribed triangular configuration shown in the first embodiment.

With the focus of this embodiment on a narrow part of the field surface, i.e., a line thereon, this sequential or serial configuration is best suited for this line removal function. It should be understood that each brush 162A and 162B (as well as brushes 122) is powered by a brush actuator, generally designated by the reference numeral 163.

As in the prior embodiment, there is a front, pre-scrub or chemical sprayer, generally designated by the reference numeral 164, deployed first, i.e., in operation, the chemicals are sprayed first onto the line for removal to help dissolve the paint on the field surface. Also shown are middle sprayers, generally designated by the reference numeral 166, deployed just before each of the brushes 162. Finally, there is shown a flood sprayer, generally designated by the reference numeral 167, deployed just before the vacuum device 143, which, as discussed, augments or floods the aforedescribed accumulated liquids and admixed particulates into liquid slurry for easy vacuuming.

As shown, two brushes 162 and the vacuum assembly 140 are shown in this embodiment, with the vacuum device 143 connected by a single exhaust hose 144 to the aforementioned suction device motor 112 atop the recovery tank 111, as shown in FIG. 6. As discussed, the modularity of this design allows interconnections of the components and functions to be deployed with the present invention configuration. As with the other embodiment, the operator of the vehicle 105 can control the positioning of the line cleaning assembly 160 and the vacuum device 143 over the desired portions of the field surface via the control panel 124. One or more actuators 142 are used to raise and lower the vacuum device 143 to the field surface, as discussed.

It should be understood that the frame 161 of the line cleaning assembly 160 can be secured to the vehicle 105 in a variety of ways. In this embodiment, the frame 161 and brushes 162, etc. are not directed attached to the vacuum assembly 140 and vacuum device 143, which are separately secured, i.e., bolted or otherwise connected to another part or side of the vehicle 105, the securement mechanism generally designated by the reference numeral 168, but nonetheless both are aligned to perform the requisite functions, i.e., suctioning up the paint and other materials for a line of paint on a field, and completely eliminating all vestiges of the unwanted paint or debris on the field surface.

It should be understood that in another embodiment the various components of the line cleaning assembly 160 are all secured to the foresaid frame 161, such as depicted in FIG. 8.

With reference now to FIG. 8 of the DRAWINGS, there is illustrated an exemplary operational configuration and process for line removal using the line cleaning assembly 160 configuration shown in FIGS. 6 and 7, although it should be understood that this description applies equally well to the first embodiments (and other aspects of the instant invention). In particular, the vehicle 105, such as shown in FIGS. 6 and 7, is disposed over a line portion to be removed, which is perpendicular to the Figure. One or more chemical sprayers 126/164 spray a paint dissolving or removing fluid in advance of the first edger brush 162B (and also bushes 122 described hereinabove), as discussed in more detail hereinabove and hereinbelow.

With the paint on the line portion so treated, the first and then the second edger brush 162A, through brushing by the bristles thereof, and with the aid of lightly sprayed or misty water from sprayers 166, remove the paint from the line, i.e., from the surfaces of the artificial fibers and infill. As discussed, the flood sprayer 167 solubilizes the dissolved paint particles and other debris within a common slurry, which is vacuumed away by the aforementioned vacuum device 143. In some alternate embodiments, the second brush 162, particularly brush 162B, is followed by a straight brush and then another sprayer 166.

In particular, the two-line brushes 162 allow the operator or user to situate the two brushes over a line, i.e., a painted line on a field surface, and proceed over that line in a manner to remove the paint from that line entirely. Also, with the use of the aforesaid vacuum device 143, the paint particles dispersed by the brushes 162 are suctioned up, thereby preventing the deleterious effects of capping and other issues due to the unwanted accumulation of the waste particles within the fibers of the artificial field turf.

With further reference to FIG. 8, illustrating the operations of the invention at the ground or turf level, at the right of the Figure, a chemical sprayer 164 sprays a paint remover onto the artificial turf surface, generally designated by the reference numeral 180, which, as mentioned hereinabove, generally consists of a plurality of artificial blades to resemble grass, generally designated by the reference numeral 181. These blades 181 also act like grass, bending when stepped on and otherwise mimicking Nature.

Under the blades 181, just like in nature, there is a hard layer called the infill, generally designated by the reference numeral 182, which in artificial field or game surfaces generally consists of a crumb rubber, again providing a measure of a natural feel. More details about the blades 181 and infill 182, as well as the operations of a synthetic field grooming and maintenance system for this artificial surface are discussed in detail hereinabove and also found in Applicant's '617 patent, which is incorporated by reference.

As shown, the line cleaning assembly 160, propelled forward (to the right in FIG. 8) by the vehicle 105, moves the assembly 160 over the painted line, which then gets sprayed with a middle water sprayer 166, which is disposed just before brush 162B, the bristles, generally designated by the reference numeral 183, engaging the aforementioned blades 181, which augments the aforesaid chemicals already sprayed to clean or remove the paint on the blades 181. As shown, the bristles 183 engage the blades 181 and not the infill 182 lower down, thereby no damaging the infill 182. Again, through operator (or perhaps automation) control, the height of the brushes 162 vis-à-vis the field surface 180 is carefully governed to clean but not harm.

After the scrubbing by the bristles 183 on brush 162B, the blades 181 of the artificial turf are again sprayed with water by another sprayer 166, both sprayers 166 providing a light mist of water. Then, the aforementioned brush 162A engages the blades 181, the bristles 183 of which likewise engage the surface 180 and the infill 182 to some extent, dislodging any remaining paint or debris from the blades 181 and accumulated along the infill 182. As is understood, the removed paint and any other debris present have been loosened, some falling toward the infill 182.

After the above chemical treatment, water washes and vigorous brush scrubbing, the turf blades 181 are then doused or flooded by sprayer 167 with a lot of water, as shown, forming a pool, bolus or slurry, generally designated herein by the reference numeral 184. This flood of water from sprayer 167 admixes the accumulated particulates in the process, forming the slurry 184, which is composed generally of water, the chemical sprayed, the removed paint and any other debris on the field surface, particularly those materials forming the line are removed (more generally any detritus on the field).

It should be understood that this slurry 184 solubilizes everything, i.e., creates an admixture solution of all of the above, making removal of the admixed debris easier, i.e., by vacuuming. In a preferred embodiment, the volume of water from the flood sprayers 167 are twice or more the volume of the middle sprayers 166.

As shown in FIG. 8, the slurry 184 forms just behind the brush 162B and builds or collects in front of the aforedescribed vacuum device 143, which has been deployed to collect the slurry 184. The vacuum device 143, pressed downwards by the operator towards the infill 182 level, preferably substantially close thereto but not touching, creates a barrier for the accumulating liquids and particulates in the common slurry 184, as shown. The slurry 184 thus passes into the vacuum device 143 in a particular way, i.e., through the aforementioned channels 147 along the base of the vacuum device 143, as shown and described in detail in connection with FIG. 5.

Since the slurry 184 is a soluble admixture or collection of water, chemicals and debris, all of this passes through the channels 147, and vacuumed away through the grate 145 of vacuum holes 146 at the bottom of the vacuum device 143, as discussed, and then the effluent passing through the exhaust hose or hoses 144 for delivery to the external recovery tank 111.

As discussed, the operator should take care in the lowering of the vacuum device 143 so as to not damage the blades 181 or the infill 182, e.g., by applying too much pressure on the surface. By use of sight, feel and the readings on the control panel 124, the operator can orient the vehicle 105, align the line cleaning assembly 160 along a line to be removed, and engage the apparatus, i.e., activate the chemical sprayer 126/164, middle sprayers 127/166, flood sprayer 129/167, lower or raise the brushes 122/162 for proper engagement, and lower the vacuum device 143 onto the infill 182 (preferably close thereto) to form the dam or blockage needed to form the slurry 184. Then, through movement of the vehicle 105 and the line cleaning assembly 160 across the painted line, the paint on the blades 181 and other materials can be treated and totally removed by vacuum and collection into the recovery tank 111.

The raising or lowering of the vacuum device 143 and the brushes 162 are preferably done by respective actuators, e.g., the aforementioned actuators 142 to raise and lower the vacuum device. and brush actuators, generally designated by the reference numeral 163. For example, the operator, using the control panel 124, can actuate an actuator 163 to raise or lower the brushes 162 in this embodiment to the appropriate level.

In this fashion, painted lines and other indicia on a field surface are more completely removed, i.e., not only the line indicia but also the paint materials and debris from the removed line, which, as discussed, alleviates capping and other problems, thereby enabling extended use of the field despite continual changes to the games and indicia. As noted, the techniques of the instant invention allow expeditious handling of entire fields, whether gathering up general detritus on a field surface, such as after a big game, or particular usages in line removal, whereby the line is eliminated, allowing the replacement with new lines.

Additionally, the downward pressures on the fibers or blades 181 must be properly governed to avoid damage to the field surface, details of which are addressed hereinbelow. Although all fields differ, operationally they are similar, and artificial turf generally has blades 1 inch to one and a half inches tall, and firmly secured to a base material, as shown and described in more detail in Applicant's '617 patent. Artificial turf also has the infill 182, which is preferably a rubbery material to provide a little bounce. The infill 182 is also secured to the base material and the blades 181 extend therethrough the roughly one half inch thick of infill 182 materials, as also shown in FIG. 8 herein. The delicacies of these materials and restrictions on their use are known, and are, again, set forth in Applicant's '167 patent, incorporated herein.

As discussed, sports turf managers have enough to worry about. Field condition and its appearance need not be one of their worries. Hydraulically actuated synthetic field grooming and now extraction implements or attachments, in combination with a corresponding tractor providing hydraulic or other activation of the attachments, makes creating a safe, playable and aesthetically pleasing field surface a manageable task. Knowing what to do and when has been difficult for field maintenance staff to decipher. And the additional problems due to new NFL rules on hardness and the need to do rapid deployment of new indicia (with full removal of the old) provide more worries.

With reference now to FIG. 9 of the DRAWINGS, there is illustrated therein a third embodiment of the instant invention, which combines the features of the aforedescribed embodiments, and is generally designated by the reference numeral 300. As in the other embodiments, a vehicle 105 is employed for propulsion. As shown, the aforementioned field cleaning assembly 120 (and all components connected thereto) used for general field cleaning, the aforementioned first embodiment, is combined with the aforedescribed line cleaning assembly 160 for painted line treatment, the second embodiment hereinabove. Although it is generally preferred that these embodiments be employed separately for more specific usages, it should be understood that this combination of equipment and functions can be useful as well, e.g., cleaning a small or medium field or a field with a lot of lines.

It should be understood that the illustrative embodiment 300 will require some adjustments to make the configuration operable, e.g., in this combined system another exhaust hose 144 is required. Other modifications will also be needed.

The exemplary embodiments shown also provide a methodology which incorporates all vacuuming and extraction functions into a complete and thorough 3-step process. The system addresses problems associated with hardness, infill compaction, fiber entanglement and capping, poor water infiltration, dust and dirt contamination and uneven infill 182 distribution. As such, an exemplary process for operation using the equipment described herein, whether generally addressing a field or a part thereof, e.g., line or logo removal, is described both hereinabove and hereinbelow.

The first step, a preparatory step, is a physical conditioning or pre-conditioning of the surface 180 in question, for example, using the instant invention, or an apparatus available from the Kromer Co. under the product name Synthetic Field Conditioning Groomer™, which is able to decompact, break up and clean clumped infill, remove magnetic debris, then redistribute and level the infill. This initial physical conditioning or grooming device provides visual feedback to the operator, letting him or her know when the field is properly prepared and ready for the second step.

It should, of course, be understood that this initial preparation step may be performed two or more times, e.g., depending on the degree of hardness, shadowing and other factors. However, this more general or surface level grooming treatment done by Applicant in earlier systems and as shown in the prior art does not address the more difficult issues, as described in more detail herein.

After completion of the first step, some loosened paint particles and redistributed infill 182 largely lay atop the surface of the grass blade fibers 181 and, if left that way, would leave the field with a dark or black appearance. But in hardened areas, the paint would be more caked onto the fibers 181, necessitating further treatment. The second step entails spraying a chemical removal onto the painted areas or hardness areas, i.e., chemical sprayer 126/164, to directly attack the embedded paint and allowing the chemicals to sit for approximately two minutes, e.g., giving the operator a chance to circle back around for the third step. Additionally, the operator can move the vehicle 105 slowly over the surface 180.

In the third step, the vehicle 105 with the aforesaid scrubbers or brushes 122/162, with a water mixture with the already deposited and powerful chemical removers and under a particular pressure, loosen the embedded paint and other debris up for collection. Through a delicate balance of downward pressure by the brushes 122/162 and the chemical remover/water mist mix employed, the techniques of the instant invention loosen for removal these engrained paint and other particles from the field surface, and for line removal, particularly loosen the adhered paint on the blades 181 along a given line.

As discussed, immediately after the brushes 122/162 comes the vacuuming by the aforedescribed and illustrated vacuum device 143 shown in FIGS. 3-5 of the admixtures formed from the chemicals, water, paint particles and other debris, and removal by suction of the admixture to the aforementioned recovery tank 111 at the rear of the vehicle 105, as depicted in FIG. 6.

Although only one such enhanced chemical treatment is normally enough, for very hard areas, the entire process can be repeated multiple times.

The instant invention thus addresses the increasingly important safety and aesthetic issues caused by paint buildup through the usage of prior art techniques and devices, such as currently employed by others in the industry. In addition to the playability, durability and safety attributes, the field surface 180 is left in an aesthetically prime, game-ready condition.

In a preferred embodiment, the various aspects of grooming, painting and removing are performed using a given vehicle 105, as shown in the Figures herein and Applicant's '617 patent, with accessories attached thereto accomplish the various tasks. As discussed, the various details as to grooming and general maintenance are set forth in detail in Applicant's aforementioned '617 patent, which is again incorporated in its entirely by reference. Additional details on paint and other debris removal are described hereinabove and hereinbelow directed to presently preferred embodiments for the components of the instant invention.

Applicant wishes to note that in connection with the usage of the equipment and components described herein, the operator may use their judgement regarding the usage of the aforesaid brushes 122/162 and the vacuum device 143, particularly since these components, e.g., the bristles 183, directly engage the aforementioned blades 181, onto which paint and other residue adheres, as well as the infill 182, which may have accumulated debris. The operator thus needs to know how far down these components should go to properly perform the tasks, as discussed hereinabove in connection with FIG. 8. As stressed, in the interest of proper usage, the placement of the various components above the infill 182 is preferred.

For example, a given field surface may have recently been cleaned or groomed vis-à-vis a field surface that is thick with the infill or other issues as described hereinabove. Accordingly, a variety of pressures are applied so that the devices can properly operate, and, knowing these pressures, the operator can monitor a gauge, such as the aforementioned control panel 124, to be sure that they are within the operational parameters.

Applicant has found that most operational pressures employed in practicing the instant invention are between about 20 to about 80 pounds per square inch. For example, the operator can apply about 20 pounds per square inch on a fairly fresh field surface, i.e., one cleaned or groomed recently and without an infill accumulation.

Conversely, the operator may apply about 80 pounds per square inch for difficult field surfaces, i.e., when operating the vacuum device 143 and or the brushes 122/162, the operator, through the control panel 124 and respective actuators, applies these components to the field surface 180 within this general pressure range.

A more preferred operational pressure range in the usage of these components lowered and raised onto the field surface 180 is about 25 to about 60 pounds per square inch, and a currently most preferred operational range of about 30 to about 50 pounds per square inch.

Applicant wishes to also note that, for proper operation, vacuum device 143 must receive sufficient suction power, from the aforementioned suction motor 112, as well as a measure of air, to properly vacuum up the slurry 184. As discussed hereinabove, the requisite vacuum power and air is generally available for the usage of the vacuum device 143 deployed in the first embodiment, where the vacuum device 143 is larger and having substantially more channels 147 and more vacuum holes 146 to supply the necessary air. In other words, the configuration of the first embodiment has plenty of suction and air necessary for that suction.

However, as discussed, the smaller vacuum device 143, configured for use with the aforementioned line cleaning assembly 160, does not have enough vacuum holes 146, and does not get enough air for proper operations. Accordingly, to supply the requisite air, an air valve, generally designated by the reference numeral 148, is shown in FIG. 3, which is affixed to a top portion of the vacuum device 143 and connected therethrough, i.e., the air valve 148 is connected to the vacuum environment and provides any necessary air for the suction, providing enough additional air for the vacuum device in this embodiment to suck up the entire slurry 184, e.g., through the aforementioned connection through the polycarbonate cover or top portion 149. Without the addition of this air from the air valve 148, the effluent in the exhaust hose 144 could pool therein and become non-functional.

It should be understood that the air valve 148 has a range of preferred air levels, e.g., level 1 being the smallest and level 5 being the most air. In operation, the operator must manually set the appropriate level of the air valve 148 for the configuration use and appropriate for the job.

It should, of course, be understood that in another embodiment of the invention, the operator could manipulate this setting through the aforesaid control panel 124. Further, with more automation, this setting could be automatically adjusted during operation, e.g., by dynamically measuring the field surface conditions.

Applicant wishes to further note that the instant invention has been developed using computer-aided design and computer-aided manufacturing principles, i.e., CAD/CAM whereby the various components are modularized, as discussed. Using CAD/CAM, the components can be precision laser cut and powder coated/painted, with infused label directions. The modularity in the design of the components and their assembly creates a high degree of quality, reliability and ease of repair and maintenance, as is understood to those of skill in this art. Preferably, the equipment and technique can be employed not only on the aforesaid synthetic athletic fields surfaces but also on other surfaces, indoor and outdoor, and including natural turf.

The propulsion system in the preferred embodiment is a V-Twin cylinder Honda GX630, 20.8 hp fin-cooled engine, having a 6-gallon capacity, preferably 5 gallon main and 1 gallon reserve, and an aluminum fuel tank with a tethered gas cap.

As mentioned, the apparatuses and systems employed in the instant invention preferably comprise a full hydraulic system with no belts or pulleys, thereby greatly increasing reliability. The propel pump is preferably an infinitely variable, bidirectional, axial piston pump design, and a directly coupled, tandem configuration, with an auxiliary accessory pump.

In at least one embodiment, the wheel motors include two fixed displacement, bidirectional, high torque orbital wheel motors with brakes rated at 7,250 pound re rear axle capacity. The aforesaid auxiliary pump is a positive displacement, gear pump, 6 cm cubed/rev and 5.46 GPM. This embodiment also includes a cooling system for the hydraulics, preferably an aluminum hydraulic fluid heat exchanger which augments the engine compartment cooling for employment in the various embodiments shown.

The specs are preferably 12V, 5.4-amp fan, 280 CFM, with a currently preferred dimension of 8 inches×8 inches×4.5 inches. The hydraulic fluid tank preferably comes with a sight gauge and internal filter, e.g., a 5.4-gallon capacity system.

Regarding preferred tires, the front tires 115 are preferably 16×17.5-8 low ground pressure 4 ply Turf Tech. Rear tires 114 are preferably 23×10.5-12 low ground pressure 4 ply Turf Tech. The wheels preferably are forward speed variable up to 14 MPH, with a reverse speed variable at 3 MPH.

With regard to the electrical system, the voltage/amperage is preferably 12 V, 20 ampere charge, with a 340 CCA/425CA battery. A 12V charger port is available for accessories. There are a number of components in a gauge package, including a hour meter, volt meter, paint PSI indicator and other gauges where necessary.

As discussed, to minimize confusion, all harness wirings are preferably in different colors, i.e., color-coded, for ease of maintenance and troubleshooting. As for electrical connectors, these are preferably commercial soft-shell pin and socket. By virtue of these improved connectors and components, these quick disconnect couplers can be used with forward accessories.

With the various paint, water, chemical tank and spraying systems, the various details and examples set forth in Applicant's aforesaid '167 patent incorporated by reference can be used as an additional template for details on implementation and use, e.g., the various brushes 122/162 and the specifics of the patterns of operation for coverage of various different field surfaces 180 and lines thereon.

One aspect of the present invention, distinguishing the instant invention from all of the prior art, is the particulars of the brushes 122/162 and the liquids applied, including the pressures of the brushes 122/162 on the surfaces, the amount of water and other chemicals applied by the sprayers 126, 128-19, 164 and 166-167, respectively, are adjustable by the operator (or perhaps programmed into an automated routine) to optimally clean, groom, soften or maintain the surface 180. Through the use of brass regulators and stainless-steel internals, these connections are better secured and durable for long life.

Further to the disclosure in the incorporated by reference patent, a preferred apparatus for practicing a portion of the instant invention is a Kromer engineered Hydro Ultra Pressure Paint Pump 290 PSI 6 GPM. This unit includes a built-in storage compartment and at least one cup holder. Using this preferred paint system, the Ultra pressure system saves up to 50% in paint—in the application stage. This apparatus is preferably used in the removal of paint, including a 17-gallon auxiliary tank for the paint removal solution, or in application, a second paint color. Further options are also available as per the desired usage.

For the main recovery tank system 111, a preferred 62.5 or 65-gallon capacity tank can be increased to an optional 104 gallon one to hold paint, water, chemicals, etc. The tank 111 should be made of a durable corrosion proof, rotomolded plastic or other robust materials. In use, the tanks 111 have ease of use, with a quick lock lid on the main tank, and a double filtration (basket filter, in-line bowl filter/strainer) system, with an in-tank agitation system also.

Further, the apparatus includes an easy rinse sloped sump system with 100% positive drain, which is generally shown in FIG. 6.

To clean the components, the apparatus and system includes a water hose flush main tank which connects to an inlet selector valve. Through these water interconnectivities, all paint nozzles, paint lines and paint pump can be cleaned in about 2 minutes, increasing the usefulness of the instant system.

Turning now to the driver's comfort in using the vehicle 105, i.e., the ergonomics, there is a large operator compartment or station 107 with a seat 108, permitting increased steering wheel 116 clearance, large foot wells, and an improved design accelerator foot pedal (not shown). The operator seat 108 can include lumbar and other support, and is adjustable—rate suspension, seat back angle, armrest height and angle, fore-aft movement and other features.

With regard to the necessary lifting during operation, such as the brushes 122/162 and the vacuum device 143, the instant invention preferably provides a foot operated lift assist, which reduces the actual effort required by 72%. Finally, the vehicle 105 has all controls clearly marked, e.g., on the control panel 124, using a particular process image infused graphics lasting durable powder coat finish, which creates easy to read and color coded and grouped controls and receptables.

With the modularity and numerous other advantages built into the design and configuration of the apparatuses and system set forth and claimed herein, the system has a high degree of versatility and numerous options for accessories, custom modifications and other flexibility.

As discussed, although the particular advantages claimed herein involve the great improvement in cleaning and overall maintenance by removal or extraction of the previously-applied paints, the vehicle 105 is versatile enough to include the various grooming, line edging and removal, prior paint removing and other aspects of the prior art, i.e., the vehicle 105 can be employed throughout the creation and painting of the lines on a field surface 180, the maintenance of those lines, and the improved removal of those lines to start the cycle anew with fresh paint lines.

Thus, the quick-change connectivity allows for the attachment of the grooming equipment, agitator/levelers, deflectors/magnets, custom Grooved Double Broom and G-Max drag, which is a proprietary technique to raise and lower (and lock) the brushes and equipment for precise depth of grooming or set in Float Mode that provides versatility for a variety of field types.

Of course, all of these operational variables also include operating in multiple conditions and speed grooming. Preferably, the field cleaning system 120 includes an end zone and logo remover, e.g., using three 20-inch brushes 122 for wide scrub patterns. The aforedescribed line remover or cleaning assembly 160 preferably has two 14-inch brushes 162 for a more concentrated line removal. The end zone and line remover preferably come with a sprayer for applying the cleaning solutions, as discussed.

It should be understood that the shape and configuration of the corrugations within the vacuum device 143 of the present invention, as depicted, can be modified. For example, the size and dimensions of the holes 146 in the grating 145 may vary from what is shown.

It should also be understood that the brushes 122/162 and water/chemical treatment by the aforementioned sprayers 126, 128-129, 164, and 166-167 before vacuuming can be done with alternate configurations, i.e., different brushes, water and chemical nozzles, higher pressure and other aspects improved, details of which can be found in Applicant's '617 patent.

The techniques of the instant invention can be employed on almost any playing field and also any even turf. Although present day athletic fields are made from a variety of synthetic materials, the instant invention is adaptable for use among these materials, including crumb rubber.

In preferred embodiments, it should be understood that the present invention, particularly the engine powering the vehicle 105, uses synthetic oil to lubricate the parts instead of the cheaper oils employed in the prior art.

Since the vehicle and the improvements set forth herein are to be employed in use on famous playing fields, the chance for an oil leak is high, and the effects of traditional oil leaks are far more devastating to the field surfaces than that caused by synthetic oils which are more easily cleaned up. As a client relations tool, the client being the purchaser of the equipment herein, i.e., the field owners, this additional feature is key.

It should be understood that although the devices and techniques show are for removing paint and debris in connection with sports games, other events, such as concerts, political rallies and other gatherings may demand similar markings on a field surface and similar quick changes.

With the improved components and techniques of the instant invention, which are significant improvements over the prior art, as well as Applicant's own earlier efforts, the current needs of our sports-driven entertainment industry and the constraints of multiple sports in a given venue are met. The suctioning or vacuuming up all of the paint particles encountered, such as on a painted line for removal is a significant improvement over all prior art techniques, and changes everything in this industry. With this improvement, a field surface can be reused and relined quickly.

The previous descriptions are of preferred embodiments for implementing the invention, and the scope of the invention should not necessarily be limited by these descriptions. Further, workers skilled in the art will recognize that changes may be made in form and detail without departing from the spirit and scope of the invention. It should be understood that all articles, references and citations recited herein are expressly incorporated by reference in their entirety. The scope of the current invention is defined by the following claims.

What is claimed is:

1. A field surface cleaning device comprising:
a frame, said frame having at least one coupling mechanism configured to attach said frame to a vehicle;
at least one chemical sprayer secured to a first end of said frame, said first end being an operational leading end of the field cleaning device, said at least one chemical sprayer configured to spray at least one paint remover chemical onto a field surface;
a plurality of brushes secured to said frame, said plurality of brushes configured to engage said field surface;
a plurality of water sprayers secured to said frame, said plurality of water sprayers configured to spray water onto said field surface ahead of each of said plurality of brushes;
at least one vacuum device, said vacuum device secured to said frame at a second end thereof after said plurality of brushes and configured to collect and remove by vacuum suction particles and liquids from said field surface; and
at least one flood sprayer secured to said frame between said at least one vacuum device and said plurality of brushes, said at least one flood sprayer configured to deliver a flood of water onto said field surface,
whereby said flood of water solubilizes said particles into a slurry, said slurry vacuumed up by said at least one vacuum device.

2. The field surface cleaning device according to claim 1, wherein said field cleaning device is coupled to a front portion of said vehicle, said vehicle in operation pushing said field surface cleaning device.

3. The field surface cleaning device according to claim 1, wherein said at least one paint remover chemical comprises a non-foaming biodegradable detergent.

4. The field surface cleaning device according to claim 1, wherein said plurality of brushes are secured to said frame and comprises three brushes arranged in a triangular configuration.

5. The field surface cleaning device according to claim 4, wherein each of said plurality of brushes are 20-inch diameter brushes.

6. The field surface cleaning device according to claim 1, wherein said plurality of brushes comprises two brushes arranged in a serial configuration.

7. The field surface cleaning device according to claim 6, wherein each of said plurality of brushes are 14-inch diameter brushes.

8. The field surface cleaning device according to claim 6, wherein said field cleaning device cleans a line of paint on said field surface.

9. The field surface cleaning device according to claim 6, wherein said plurality of brushes are configured to attach to a side of said vehicle

10. The field surface cleaning device according to claim 1, further comprising a control panel secured to said frame and extending to an operator station of said vehicle, whereby an operator can adjust a plurality of operational features through said control panel.

11. The field surface cleaning device according to claim 10, further comprising at least one actuator, said at least one actuator configured to lower and raise said plurality of brushes and controlled via said control panel, said plurality of brushes and a plurality of bristles thereof when lowered engaging said field surface and any paint particles thereon.

12. The field surface cleaning device according to claim 1, wherein said plurality of water sprayers are configured to spray a water mist onto said field surface.

13. The field surface cleaning device according to claim 1, wherein said vacuum device, along an underside thereof, has a plurality of vacuum holes, whereby said plurality of vacuum holes suction up and away said liquid slurry.

14. The field surface cleaning device according to claim 13, wherein said vacuum device further comprises a plurality of channels along a leading end of said vacuum device, said plurality of channels configured to connect said liquid slurry to said plurality of vacuum holes, whereby said plurality of channels allow said liquid slurry to flow therethrough to said plurality of vacuum holes.

15. The field surface cleaning device according to claim 1, wherein said at least one vacuum device comprises at least one port, said at least one port configured to connect said vacuum device to a suction source.

16. The field surface cleaning device according to claim 15, wherein said at least one port connects to an exhaust hose at one end, and wherein said exhaust hose at the other end connects to said suction source, whereby said liquid slurry and particles therein are removed from said field surface by suction from said suction source.

17. The field surface cleaning device according to claim 1, wherein said field surface is artificial.

18. A field surface line removing device comprising:
a frame, said frame having at least one coupling mechanism configured to attach said frame to a vehicle;
at least one chemical sprayer secured to a first end of said frame, said first end being an operational leading end of the field surface line removing device, said at least one chemical sprayer configured to spray at least one paint remover chemical onto a field surface;
a plurality of brushes secured to said frame, said plurality of brushes configured to engage said field surface, said plurality of brushes arranged serially;
a plurality of water sprayers secured to said frame, said plurality of water sprayers configured to spray water onto said field surface ahead of each of said plurality of brushes;
at least one vacuum device, said vacuum device secured to said frame at a second end thereof after said plurality of brushes and configured to collect and remove by vacuum suction particles and liquids from said field surface; and
at least one flood sprayer secured to said frame between said at least one vacuum device and said plurality of brushes, said at least one flood sprayer configured to deliver a flood of water onto said field surface,
whereby said flood of water solubilizes said particles into a slurry, said slurry vacuumed up by said at least one vacuum device,
whereby a line of paint on said field surface is removed by vacuum.

19. A method for cleaning a line of paint from a field surface comprising
connecting a line cleaning assembly to a vehicle;
aligning the vehicle with the line cleaning assembly covering a line of paint on a field surface designated for removal;
spraying said line with a paint remover chemical;
brushing the line with two brushes arranged serially;
water rinsing the line before and after each of said brushes, a final water spray being at least twice the volume of the other water sprayers, forming a slurry, said slurry being an admixture of liquids and particulates; and
positioning a vacuum device to collect said slurry, said slurry being vacuumed to a recovery tank.
